(19) United States
(12) Patent Application Publication
(10) Pub. No.: US 2026/0276368 A1
(43) Pub. Date: Sep. 17, 2026

(54) OPTICAL SENSOR

(71) Applicant: HONDA MOTOR CO., LTD., Tokyo (JP)

(72) Inventor: Hironori WAITA, Saitama (JP)

(21) Appl. No.: 19/533,950

(22) Filed: Feb. 9, 2026

(30) Foreign Application Priority Data
Mar. 14, 2025 (JP) 2025-041210

(51) Int. Cl. G01B 11/16; G01B 11/24; H04N 23/51; H04N 23/55; H04N 23/57; H04N 23/58

(52) U.S. Cl. CPC G01B 11/165; G01B 11/24; H04N 23/51; H04N 23/55; H04N 23/57; H04N 23/58

(57) ABSTRACT

An optical sensor includes a contact member including a contact surface, a support member supporting the contact member, an imaging element provided on the support member to image the contact surface, and a first optical path forming mirror provided on the contact member and forming a first optical path inside the contact member. The first optical path is configured to guide a light ray having a first emission angle from the contact surface to a first area that is a portion of the imaging element. The imaging element is configured to receive, in the first area, the light ray from the first optical path, and receive, in a second area different from the first area, a light ray having a second emission angle different from the first emission angle and coming from the contact surface via a second optical path different from the first optical path.

### TECHNICAL FIELD

The present invention relates to an optical sensor.

### BACKGROUND ART

A known optical sensor images a contact surface, which elastically deforms upon contact with a target object, from inside an elastic body using a plurality of electronic cameras (for example, US12025525B2 and US2023/0074958A1).

In a conventional optical sensor, two electronic cameras (imaging elements) are required to image a target object in two different field-of-view directions. This makes it difficult to make the optical sensor compact and downsize the optical sensor.

### SUMMARY OF THE INVENTION

In view of the above background, an object of the present invention is to provide an optical sensor that can image a target object in two different field-of-view directions with a compact configuration.

To achieve such an object, one aspect of the present invention provides an optical sensor comprising: a contact member having light permeability and including a contact surface configured to come into contact with a target object; a support member supporting the contact member; an imaging element provided on the support member to image the contact surface from inside the contact member; and a first optical path forming mirror provided on the contact member and forming a first optical path inside the contact member, the first optical path configured to guide a light ray having a first emission angle from the contact surface to a first area that is a portion of the imaging element, wherein the imaging element is configured to receive, in the first area, the light ray from the first optical path; and receive, in a second area different from the first area, a light ray having a second emission angle different from the first emission angle and coming from the contact surface via a second optical path different from the first optical path.

According to this aspect, the optical sensor can image a target object in two different field-of-view directions with a compact configuration.

### BRIEF DESCRIPTION OF THE DRAWING(S)

FIG. 1 is a perspective view of an end effector of a robot arm into which an optical sensor according to the present embodiment is incorporated;

FIG. 2 is a vertical cross-sectional view of the optical sensor according to the present embodiment;

FIG. 3 is a front view of an imaging element used for the optical sensor according to the present embodiment; and

FIGS. 4A and 4B are explanatory diagrams of a pattern used for the optical sensor according to the present embodiment.

### DETAILED DESCRIPTION OF THE INVENTION

In the following, an optical sensor according to an embodiment of the present invention will be described with reference to the drawings.

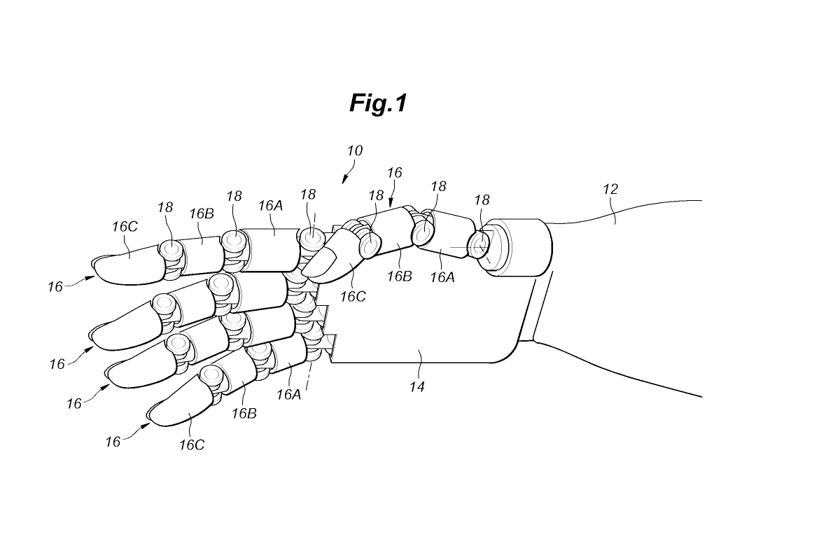

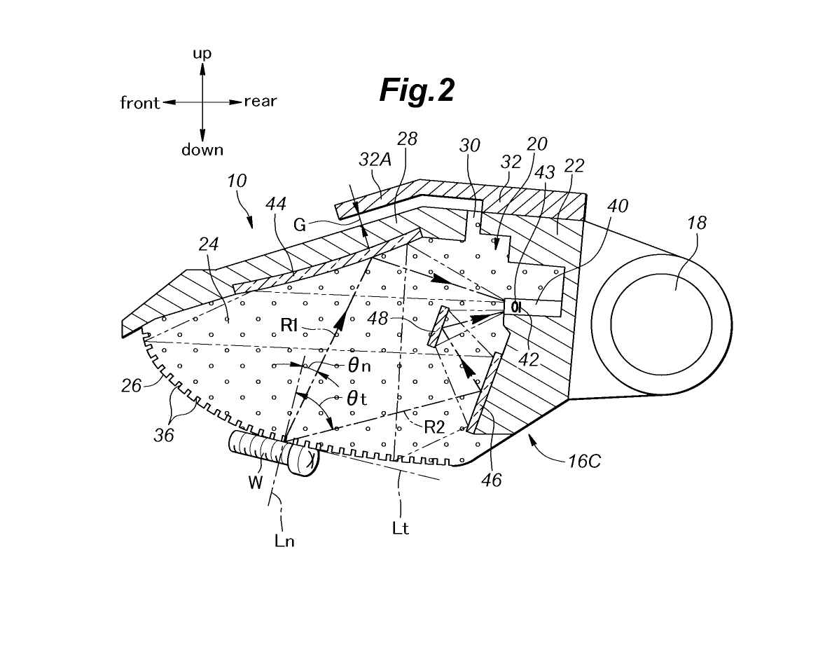

FIG. 1 shows an end effector 10 at the tip of a robot arm 12 into which an optical sensor 20 (see FIG. 2) according to the present embodiment is incorporated.

The end effector 10 is shaped like a human hand including a palm 14 and five fingers 16 provided on the palm 14. Each finger 16 has a base portion 16A, a middle portion 16B, and a tip portion 16C that are connected to each other so as to bend and extend via a plurality of rotating portions 18 corresponding to joints.

As shown in FIG. 2, an optical sensor 20 is provided on the tip portion 16C of the finger 16 corresponding to the thumb. Optical sensors 20 may also be provided on the tip portions 16C of the fingers 16 corresponding to the index finger, the middle finger, the ring finger, and the little finger.

The optical sensor 20 includes a support member 22 attached to the rotating portion 18. A contact member 24, which is shaped like a human fingertip, is integrally provided on a front side as viewed in FIG. 2 of the support member 22. The contact member 24 is a molded product made of an elastic body (elastomer body) having light permeability, such as transparent urethane rubber, and is joined to the support member 22. The contact member 24 has a contact surface 26, which is a curved surface that can come into contact with a target object W, on a lower side as viewed in FIG. 2. In the following description, a bolt will be referred to as the target object W.

The contact member 24 is provided with a pattern 36 formed along the contact surface 26. The pattern 36 is composed of a lattice arrangement, grooves such as stripes in the front-and-rear direction or lateral direction, or dot-like recesses such as hemispherical recesses.

A back plate 28, which is shaped like a human nail, is joined to a side (an upper side as viewed in FIG. 2) of the contact member 24 facing away from the contact surface 26. The back plate 28 is made of metal or resin and has higher rigidity than the contact member 24.

The support member 22 and the back plate 28 may be joined to the contact member 24 by insert molding of the contact member 24.

From a different perspective, the back plate 28 is connected to the support member 22 via an elastic member 30. The elastic member 30 is formed by a portion of the contact member 24. With the elastic member 30 serving as a flexible hinge, the back plate 28 can move together with the contact member 24 relative to the support member 22 substantially in the up-and-down direction as viewed in FIG. 2.

A stopper member 32 is attached to the support member 22. The stopper member 32 includes a stopper piece 32A facing the upper surface of the back plate 28 at a prescribed interval G as viewed in FIG. 2. The stopper member 32 defines an upward moving range as viewed in FIG. 2 of the back plate 28 as the back plate 28 comes into contact with the stopper piece 32A.

A camera 40 is attached to a side of the support member 22 facing the contact member 24. The camera 40 is an electronic imager (imaging device) including a rectangular imaging element 42 such as a CCD or CMOS, a lens 43, and the like, and is capable of capturing static images and videos. The camera 40 does not necessarily require the lens 43.

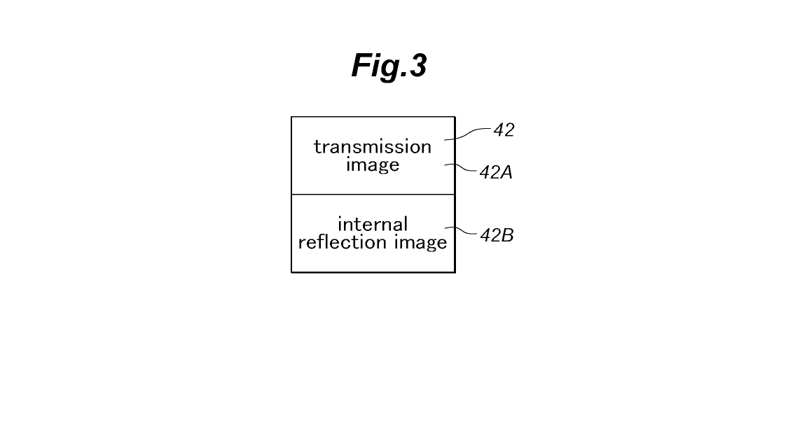

The camera 40 is provided on the support member 22 and faces forward to image the contact surface 26 from inside the contact member 24. As shown in FIG. 3, the imaging element 42 is divided into an upper area 42A as an upper half and a lower area 42B as a lower half. The upper area 42A receives a first light ray guided to the upper area 42A via a first optical path R1 formed in the contact member 24. The lower area 42B receives a second light ray guided to the lower area 42B via a second optical path R2 formed in the contact member 24.

A first optical path forming mirror 44 (hereinafter referred to as the first mirror 44) that forms the first optical path R1 is attached to a surface (a lower surface as viewed in FIG. 2) of the back plate 28 facing the contact member 24. The first mirror 44 is composed of a total reflection convex mirror, and is directed to the contact surface 26 from inside the contact member 24. The first mirror 44 guides the first light ray having a first emission angle θn from the contact surface 26 to the upper area 42A of the imaging element 42 via the first optical path R1. The first emission angle θn is an angle equal to or less than a critical angle for total reflection of the contact surface 26.

The upper area 42A of the imaging element 42 of the camera 40 images the contact surface 26 from inside the contact member 24 in a viewing direction close to the direction of a normal Ln of the contact surface 26 via the first optical path R1. Accordingly, the camera 40 images the external environment of the contact surface 26 from inside the contact member 24 through the contact surface 26. In other words, the camera 40 captures a transmission image that passes through the contact surface 26 from outside the contact surface 26 and arrives inside the contact member 24 in the viewing direction close to the normal Ln of the contact surface 26.

Second optical path forming mirrors 46, 48 (hereinafter referred to as the second mirrors 46, 48) that form a second optical path R2 are attached inside the contact member 24. The second mirrors 46, 48 are arranged in the prescribed positions in the contact member 24 by insert molding of the contact member 24. The second mirrors 46, 48 are both total reflection mirrors, are parallel to each other, and fold the second optical path R2 in the front-and-rear direction inside the contact member 24.

The second mirrors 46, 48 form two folding points in the second optical path R2. Accordingly, the emission angle of the light ray (the second light ray) incident on the camera 40 from the contact surface 26 is decreased. Further, the second optical path R2 becomes longer. Accordingly, the area of the contact surface 26 the imaging element 42 of the camera 40 can image in the lower area 42B is increased.

Since the second optical path R2 is repeatedly folded in the front-and-rear direction inside the contact member 24 by the second mirrors 46, 48, the total length of the second optical path R2 is increased, but the length in the front-and-rear direction of the entire second optical path R2 is shortened. This results in downsizing of the contact member 24 in the front-and-rear direction.

The second mirrors 46, 48 guide the light ray (the second light ray) having the second emission angle θt from the contact surface 26 to the lower area 42B of the imaging element 42 via the second optical path R2. The second emission angle θt is an angle greater than the critical angle for the total reflection of the contact surface 26.

The lower area 42B of the imaging element 42 of the camera 40 images the contact surface 26 from inside the contact member 24 in the viewing direction close to the direction of a tangent Lt of the contact surface 26 via the second optical path R2. Accordingly, the camera 40 captures, as an internal reflection image, the contact surface 26 and the pattern 36 along the contact surface 26 from inside the contact member 24 using the contact surface 26 as a reflection surface.

In this way, the upper area 42A and the lower area 42B of the imaging element 42 capture images in different viewing directions (different field-of-view directions).

Further, the first emission angle θn equal to or less than the critical angle for the total reflection of the contact surface 26 and the second emission angle θt greater than the critical angle for the total reflection thereof are angles that exist on one virtual plane perpendicular to the contact surface 26 in a state where the contact member 24 does not elastically deform, as shown in FIG. 2.

The area of the contact surface 26 imaged by the camera 40 is a gently curved area of the contact surface 26 with a large curvature that exists mainly in the central area of the contact surface 26.

Generally, it is thought that most of the area of the contact surface 26 with which the target object W comes into contact is the central area of the contact surface 26, which is a gently curved area with a large curvature. Accordingly, in many cases, the camera 40 can image the contact surface 26 at the first emission angle θn equal to or less than the critical angle for the total reflection and at the second emission angle θt greater than the critical angle for the total reflection, even if the contact surface 26 is a curved surface.

When the contact surface 26 elastically deforms according to the shape of the target object W, an elastically deforming portion where the angle of the contact surface 26 relative to the second optical path R2 becomes equal to or greater than the critical angle for the total reflection may occur. This portion of the contact surface 26 changes from an internal reflection surface to a light transmission surface. In such a case, the lower area 42B of the imaging element 42 images, in a light transmission manner, the contact portion of the target object W, which corresponds to the portion where the contact surface 26 changes from an internal reflection surface to a light transmission surface. The image information acquired by this imaging can also be used to detect that the target object W comes into contact with the contact surface 26.

Since the elastic deformation of the contact surface 26 changes according to the pressing force acting on the contact surface 26 due to contact with the target object W, the internal reflection of the contact surface 26 changes according to the pressing force of the target object W against the contact surface 26. Accordingly, it is possible to quantitatively measure the pressing force of the contact surface 26 against the target object W based on the image information from the lower area 42B of the imaging element 42. This allows the optical sensor 20 to function as a touch sensor.

Since the contact member 24 is made of an elastic body such as urethane rubber, the elastic deformation of the contact surface 26 is large when the target object W comes into contact with the contact surface 26. This results in a greater change in the state of the internal reflection of the contact surface 26 when the target object W comes into contact with the contact surface 26, which makes it possible to more reliably detect that the target object W comes into contact with the contact surface 26 and more reliably measure the pressing force.

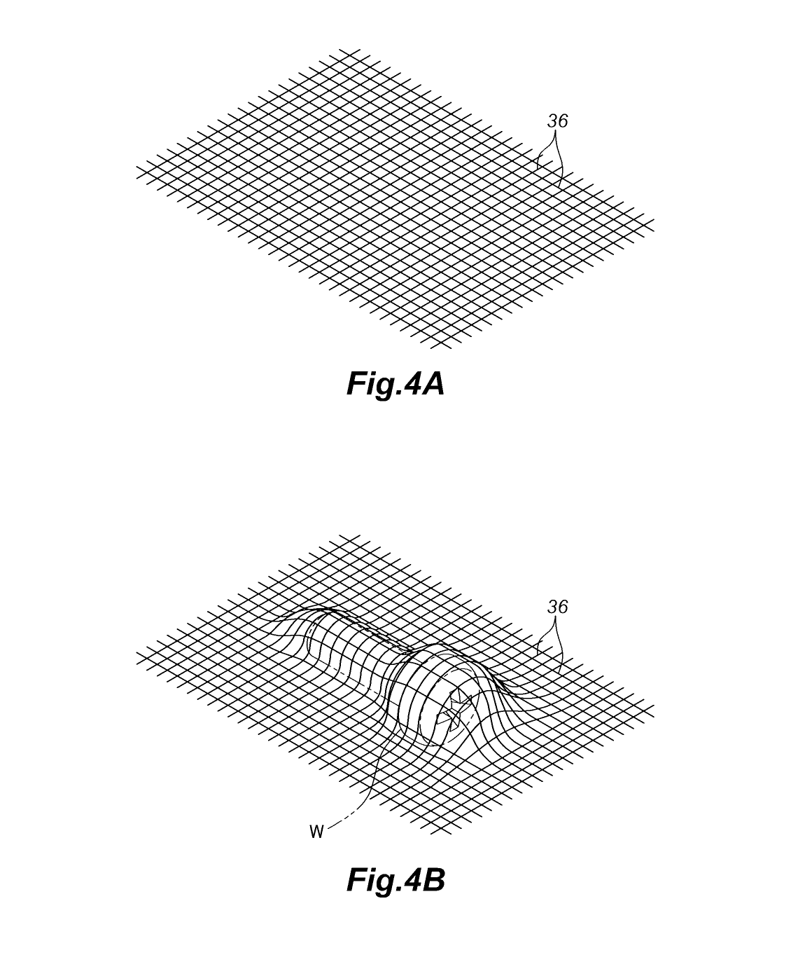

FIGS. 4A and 4B show a schematic diagram of the pattern 36 provided on the contact member 24 using wireframe drawing. As the target object W comes into contact with the contact surface 26, the pattern 36 provided on the contact member 24 along the contact surface 26 is deformed from a planar lattice shown in FIG. 4A to a three-dimensional (3D) lattice shown in FIG. 4B that follows the shape of the target object W.

The lower area 42B of the imaging element 42 utilizes the contact surface 26 as a reflection surface and images the contact surface 26 and the pattern 36 as internal reflection images, so that the image information from the lower area 42B includes the image information about the above-mentioned deformation of the pattern 36. By using the image information about the pattern 36, it is possible to more reliably detect that the target object W comes into contact with the contact surface 26, and quantitatively measure the pressing force with high precision.

The back plate 28, which has higher rigidity than the contact member 24, is a support member for the first mirror 44 and also acts as a member to absorb the reaction force that occurs when the contact member 24 elastically deforms.

This ensures that the contact member 24 elastically deforms when the target object W comes into contact with the contact surface 26, and it is possible to surely detect that the target object W comes into contact with the contact surface 26 based on the image information from the imaging element 42.

When the pressing force acts on the contact surface 26, the back plate 28 moves upward as viewed in FIG. 2 together with the first mirror 44 relative to the support member 22 with the elastic member 30 serving as a flexible hinge. This movement reduces fluctuations in the positional relationship between the contact surface 26 and the first mirror 44.

Accordingly, even if the contact surface 26 elastically deforms, the imaging angle of the camera 40 relative to the contact surface 26 is prevented from changing, and the camera 40 can capture the whole image of the target object W well.

Since the moving range of the back plate 28 in the substantially upward direction is defined by the stopper member 32, excessive movement of the back plate 28 in the substantially upward direction is suppressed, and therefore excessive elastic deformation of the contact member 24 is also suppressed. This improves the durability of the optical sensor 20.

As described above, the camera 40 simultaneously captures the transmission image of the contact surface 26 by the upper area 42A of the imaging element 42 and the internal reflection image of the contact surface 26 by the lower area 42B of the imaging element 42. This allows the camera 40 to acquire the information about the image in different viewing directions, that is, the two viewpoint image, in the upper area 42A and the lower area 42B of the imaging element 42.

In this way, according to the present embodiment, the determination and recognition of the shape, position and posture of the target object W based on the image information about the transmission image, and the detection of the contact of the target object W with the contact surface 26 based on the image information about the internal reflection image can be performed compactly using a single camera 40.

Accordingly, it is possible to make the optical sensor 20 compact. The optical sensor 20 is provided on the fingertip of the end effector 10, which is shaped like a human hand, and therefore required to be compact due to the size of the fingertip. Accordingly, making the optical sensor 20 compact is particularly useful when using the optical sensor 20 in the end effector 10.

The embodiment is not limited to the above configuration and can be widely modified and implemented. For example, the optical sensor 20 according to the present embodiment is not limited to the acquisition of the image information from two different viewpoints related to the critical angle for the total reflection of the contact surface 26. The optical sensor 20 according to the present embodiment may have any configuration as long as the optical sensor 20 can acquire the information about the image in different viewing directions, that is, the two viewpoint image, in the upper area 42A and the lower area 42B of the imaging element 42 of one camera 40.

The ratio between the upper area 42A and the lower area 42B is not limited to "1:1" to divide the imaging element 42 equally, but may be a ratio to divide the imaging element 42 unequally. The upper area 42A and the lower area 42B may be reversed so that the first optical path R1 guides an image to the lower area 42B and the second optical path R2 guides an image to the upper area 42A. Such an arrangement can be set with high flexibility in design according to the design of the first optical path R1 and the second optical path R2, the arrangement of the first mirror 44 and the second mirrors 46 and 48, and the like.

The contact member 24 may be elastically deformable as being composed of an elastomer gel and a coating skin that have equivalent refractive indexes. In this case, the pattern 36 may be provided by printing and the like on the surface of the coating skin facing the elastomer gel. A light source such as an LED may be provided to illuminate the contact surface 26 from inside.

The second mirrors 46 and 48 are not necessarily provided. In a case where the second mirrors 46 and 48 are not provided, the camera 40 may preferably be arranged at a low position (a lower position as viewed in FIG. 2) to directly receive the light ray of the second optical path R2 emitted from the contact surface 26 at the emission angle θt greater than the critical angle for the total reflection.

The second mirror 46 may be composed of a half mirror, and a light source (not shown) that can be externally controlled to blink may be arranged outside the field of view of the camera 40 in the contact member 24. The difference in brightness between the front surface side and the rear surface side of the second mirror 46 may be inverted by the blink of the light source. Under the half mirror action of the second mirror 46, the light ray of the first optical path R1 and the light ray of the second optical path R2 may be received by the imaging element 42 in a time-division manner. In this case, the second mirror 46 can be arranged in the first optical path R1, which increases the flexibility in the arrangement of optical elements such as the camera 40, the first mirror 44, and the second mirrors 46, 48 in the contact member 24.

The above embodiment may also be described as follows:

In one embodiment, an optical sensor 20 comprises: a contact member 24 having light permeability and including a contact surface 26 configured to come into contact with a target object W; a support member 22 supporting the contact member 24; an imaging element 42 provided on the support member 22 to image the contact surface 26 from inside the contact member 24; and a first optical path forming mirror 44 provided on the contact member 24 and forming a first optical path R1 inside the contact member 24, the first optical path R1 configured to guide a light ray having a first emission angle θn from the contact surface 26 to an upper area 42A (a portion of a first area) of the imaging element 42, wherein the imaging element 42 is configured to receive, in the upper area 42A, the light ray from the first optical path R1; and receive, in a lower area 42B (a second area) different from the upper area 42A, a light ray having a second emission angle θt different from the first emission angle θn and coming from the contact surface 26 via a second optical path R2 different from the first optical path R1.

According to this aspect, the upper area 42A and the lower area 42B of the imaging element 42 can image the target object W in different viewing directions with a compact configuration.

In the above embodiment, preferably, the optical sensor 20 further comprises a second optical path forming mirror 46, 48 provided on the contact member 24 and forming the second optical path R2.

According to this aspect, by using the second optical path forming mirror 46, 48, the second optical path R2 can be formed with a high flexibility in design.

In the above embodiment, preferably, the second optical path forming mirror 46, 48 includes two mirrors facing each other.

According to this aspect, it is possible to make the optical sensor 20 compact by repeatedly folding the second optical path R2.

In the above embodiment, preferably, the first emission angle θn is equal to or less than a critical angle for total reflection of the contact surface 26, and the second emission angle θt is greater than the critical angle for the total reflection of the contact surface 26.

According to this aspect, in one imaging element 42, the image information about the transmission image of the contact surface 26 and the image information about the internal reflection image thereof can be acquired.

In the above embodiment, preferably, the imaging element 42 is configured to: capture, in the upper area 42A, a transmission image based on a light ray that has passed through the contact surface 26; and capture, in the lower area 42B, an internal reflection image based on a light ray reflected by the contact surface 26.

According to this aspect, the image information about the transmission image of the contact surface 26 is acquired in the upper area 42A of one imaging element 42, and the image information about the internal reflection image of the contact surface 26 is acquired in the lower area 42B of the one imaging element 42.

In the above embodiments, preferably, the contact member 24 is made of an elastic body configured to elastically deform upon contact with the target object W.

According to this aspect, using the image information acquired by the imaging element 42, it is possible to reliably detect that the target object W comes into contact with the contact surface 26 based on the elastic deformation of the contact member 24 caused by the contact of the target object W with the contact surface 26.

In the above embodiments, preferably, the contact member 24 is provided with a pattern 36 formed along the contact surface 26.

According to this aspect, the imaging element 42 images the deformation of the pattern 36 due to the elastic deformation of the contact surface 26, so that it is possible to reliably detect that the target object W comes into contact with the contact surface 26 based on the image information acquired by the imaging element 42.

In the above embodiments, preferably, the optical sensor 20 further comprises a back plate 28 having higher rigidity than the contact member 24 and joined to a side of the contact member 24 facing away from the contact surface 26.

According to this aspect, the back plate 28 absorbs the reaction force generated by the elastic deformation of the contact member 24, which ensures that the contact member 24 elastically deforms when the target object W comes into contact with the contact surface 26, and it is possible to reliably detect that the target object W comes into contact with the contact surface 26 based on the image information from the imaging element 42.

In the above embodiment, preferably, the first optical path forming mirror 44 is provided on a side of the back plate 28 facing the contact member 24.

According to this aspect, the end effector 10 bears the reaction force generated by the elastic deformation of the contact member 24 and also functions as the support member of the first mirror 44.

1. An optical sensor, comprising:
a contact member having light permeability and including a contact surface configured to come into contact with a target object;
a support member supporting the contact member;
an imaging element provided on the support member to image the contact surface from inside the contact member; and
a first optical path forming mirror provided on the contact member and forming a first optical path inside the contact member, the first optical path configured to guide a light ray having a first emission angle from the contact surface to a first area that is a portion of the imaging element,
wherein the imaging element is configured to
receive, in the first area, the light ray from the first optical path; and
receive, in a second area different from the first area, a light ray having a second emission angle different from the first emission angle and coming from the contact surface via a second optical path different from the first optical path.

2. The optical sensor according to claim 1, further comprising a second optical path forming mirror provided on the contact member and forming the second optical path.

3. The optical sensor according to claim 2, wherein the second optical path forming mirror includes two mirrors facing each other.

4. The optical sensor according to claim 1, wherein the first emission angle is equal to or less than a critical angle for total reflection of the contact surface, and
the second emission angle is greater than the critical angle for the total reflection of the contact surface.

5. The optical sensor according to claim 4, wherein the imaging element is configured to:
capture, in the first area, a transmission image based on a light ray that has passed through the contact surface; and
capture, in the second area, an internal reflection image based on a light ray reflected by the contact surface.

6. The optical sensor according to claim 1, wherein the contact member is made of an elastic body configured to elastically deform upon contact with the target object.

7. The optical sensor according to claim 1, wherein the contact member is provided with a pattern formed along the contact surface.

8. The optical sensor according to claim 6, further comprising a back plate having higher rigidity than the contact member and joined to a side of the contact member facing away from the contact surface.

9. The optical sensor according to claim 8, wherein the first optical path forming mirror is provided on a side of the back plate facing the contact member.
